(19) United States
(12) Patent Application Publication
(10) Pub. No.: US 2025/0024092 A1
(43) Pub. Date: Jan. 16, 2025

(54) LIGHT RECEIVING DEVICE AND DISPLAY APPARATUS

(71) Applicant: SHARP KABUSHIKI KAISHA, Sakai City (JP)

(72) Inventor: KOHJI MIYAUCHI, Sakai City (JP)

(21) Appl. No.: 18/766,672

(22) Filed: Jul. 9, 2024

(30) Foreign Application Priority Data
Jul. 11, 2023 (JP) 2023-113704

(51) Int. Cl. H04N 21/422; G02B 6/10

(52) U.S. Cl. CPC H04N 21/42221; G02B 6/102; H04N 21/42202

(57) ABSTRACT

A light receiving device includes an optical sensor having a light receiving surface, and a light guide having an incidence surface on which a light ray is incident, an emission surface through which the light ray is emitted toward the light receiving surface, and a boundary surface that directs the light ray incident from a side where the incidence surface is present toward the light receiving surface.

### BACKGROUND OF THE INVENTION

### Field of the Invention

The present disclosure relates to a light receiving device and a display apparatus.

### Description of the Background Art

In the prior art, a light receiving device is known. In the light receiving device, remote control signal light is incident on the incidence surface of a light guide. In addition, the incident remote control signal light is reflected and refracted inside the light guide. Further, the reflected and refracted remote control signal light is emitted from the emission surface of the light guide. Furthermore, the emitted remote control signal light is received by the light receiving window of a light receiving sensor.

In the light receiving device known in the prior art, only remote control signal light incident on a range having substantially the same size as that of the light receiving window can be guided to the light receiving window. Therefore, when the light guide is made thinner or the light receiving sensor is made smaller, the remote control signal light that can be guided to the light receiving window is reduced. As a result, the light receiving efficiency of the light receiving device is lowered.

The present disclosure has been made in view of this problem. An object of one aspect of the present disclosure is to provide, for example, a light receiving device having high light receiving efficiency.

### SUMMARY OF THE INVENTION

A light receiving device according to a first aspect of the present disclosure includes an optical sensor having a light receiving surface, and a light guide having an incidence surface on which a light ray is incident, an emission surface through which the light ray is emitted toward the light receiving surface, and a boundary surface that directs the light ray incident from a side where the incidence surface is present toward the emission surface.

A light receiving device according to a second aspect of the present disclosure includes the light receiving device according to the first aspect of the present disclosure and a display apparatus body to which the light receiving device is attached.

### BRIEF DESCRIPTION OF THE DRAWINGS

FIG. 1 is a perspective view schematically illustrating a display apparatus of a first embodiment.

FIG. 2 is a front view schematically illustrating a state where a light receiving device provided in the display apparatus of the first embodiment does not emit indicator light.

FIG. 3 is a front view schematically illustrating a state where the light receiving device provided in the display apparatus of the first embodiment emits indicator light.

FIG. 4 is a perspective view schematically illustrating the light receiving device provided in the display apparatus of the first embodiment.

FIG. 5 is a perspective view schematically illustrating the light receiving device provided in the display apparatus of the first embodiment.

FIG. 6 is a perspective view schematically illustrating a light guide provided in the display apparatus of the first embodiment.

FIG. 7 is a cross-sectional view schematically illustrating a first optical sensor, a second optical sensor, a light emitting element, a light guide, and a substrate provided in the display apparatus of the first embodiment.

FIG. 8 is a cross-sectional view schematically illustrating the light guide and the substrate provided in the display apparatus of the first embodiment.

FIG. 9 is a cross-sectional view schematically illustrating a state of the light guide and the substrate provided in the display apparatus of the first embodiment in the middle of fixing the substrate to the light guide.

FIG. 10 is a cross-sectional view schematically illustrating a state of the light guide and the substrate provided in the display apparatus of the first embodiment in the middle of fixing the substrate to the light guide.

FIG. 11 are images illustrating a locus of an incident light ray included in remote control light incident on the light receiving device provided in the display apparatus of the first embodiment, a distribution of density of incident light rays reaching the first optical sensor, the second optical sensor, the light emitting element, and the substrate provided in the light receiving device, and a distribution of density of incident light rays reaching the first sensor.

FIG. 12 is a front view schematically illustrating a first optical sensor, a light emitting element, and a substrate provided in a display apparatus of a second embodiment.

FIG. 13 is a top view schematically illustrating the first optical sensor, the light emitting element, a light guide, and the substrate provided in the display apparatus of the second embodiment.

FIG. 14 is a front view schematically illustrating a first optical sensor, a light emitting element, and a substrate provided in a display apparatus of a third embodiment.

FIG. 15 is a top view schematically illustrating the first optical sensor, the light emitting element, a light guide, and the substrate provided in the display apparatus of the third embodiment.

FIG. 16 is a side view schematically illustrating the first optical sensor, the light emitting element, the light guide, and the substrate provided in the display apparatus of the third embodiment.

FIG. 17 is a bottom view schematically illustrating a light receiving device provided in a display apparatus of a fourth embodiment.

FIG. 18 is a perspective view schematically illustrating the light receiving device provided in the display apparatus of the fourth embodiment.

### DESCRIPTION OF THE PREFERRED EMBODIMENTS

Hereinafter, an embodiment of the present disclosure will be described with reference to the drawings. In the drawings, the same or equivalent elements are denoted by the same reference numerals, and the duplicate description will be omitted.

### 1. First Embodiment

### 1.1 Display Apparatus

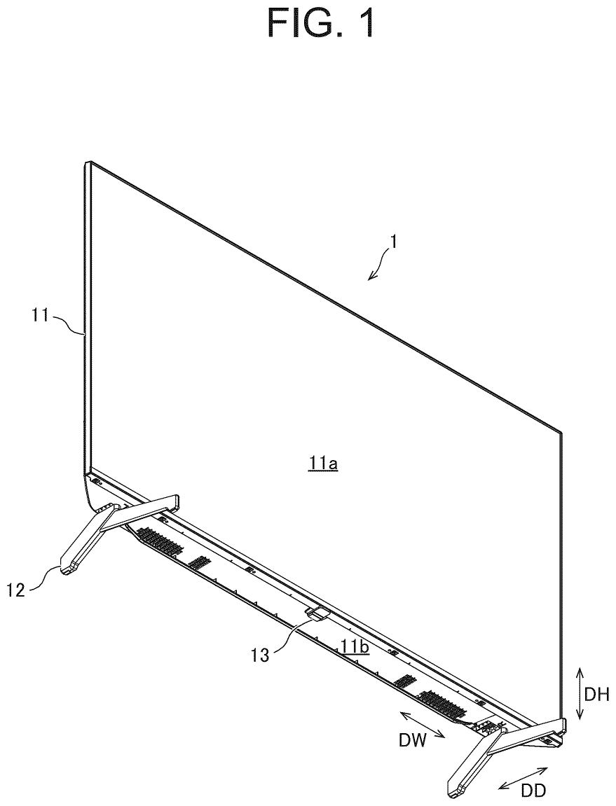

FIG. 1 is a perspective view schematically illustrating a display apparatus of a first embodiment.

A display apparatus 1 of the first embodiment illustrated in FIG. 1 is a television receiver. The display apparatus 1 may be a display apparatus other than a television receiver. For example, the display apparatus 1 may be a monitor-integrated personal computer, a monitor for a personal computer, a digital signage, or the like.

The display apparatus 1 displays a video and outputs audio.

The display apparatus 1 receives remote control light coming from a remote controller (hereinafter referred to as “remote control”), and operates in accordance with the received remote control light. For example, the display apparatus 1 is turned on when the received remote control light is remote control light for instructing the display apparatus 1 to be turned on. In addition, the display apparatus 1 stands by when the received remote control light is remote control light for instructing the display apparatus 1 to stand by. Moreover, the display apparatus 1 changes the channel to be selected when the received remote control light is the remote control light for instructing the change of the channel to be selected. Further, the display apparatus 1 changes the volume of the audio to be output when the received remote control light is the remote control light for instructing to change the volume of the audio to be output. Furthermore, the display apparatus 1 changes the input source to be selected when the received remote control light is the remote control light for instructing to change the input source to be selected.

The display apparatus 1 receives environmental light coming from an environment in which the display apparatus 1 is installed, and adjusts a video to be displayed in accordance with the received environmental light. For example, the display apparatus 1 adjusts the brightness of the video to be displayed in accordance with the brightness of the received environmental light, and adjusts the color temperature of the video to be displayed in accordance with the color temperature of the received environmental light.

As illustrated in FIG. 1, the display apparatus 1 includes a display apparatus body 11, a stand 12, and a light receiving device 13.

The display apparatus body 11 has a rectangular plate-like shape. Therefore, the display apparatus body 11 has a front surface 11a and a bottom surface 11b. The front surface 11a is disposed on the front side in a depth direction DD of the display apparatus 1 and faces the front in the depth direction DD. The bottom surface 11b is disposed on the lower side of the display apparatus 1 in a height direction DH and faces downward in the height direction DH. The display apparatus body 11 displays a video on the front surface 11a and outputs audio from the bottom surface 11b.

The stand 12 supports the display apparatus body 11.

The light receiving device 13 receives remote control light and transmits a signal corresponding to the received remote control light to the display apparatus body 11. The display apparatus body 11 receives the transmitted signal from the light receiving device 13 and operates in accordance with the received signal. Thus, the display apparatus body 11 operates in accordance with the remote control light received by the light receiving device 13.

The light receiving device 13 receives environmental light and transmits a signal corresponding to the received environmental light to the display apparatus body 11. The display apparatus body 11 receives the transmitted signal from the light receiving device 13, and adjusts the video to be displayed in accordance with the received signal. Thus, the display apparatus body 11 adjusts the video to be displayed in accordance with the environmental light received by the light receiving device 13.

The display apparatus body 11 transmits a signal indicating that the display apparatus body 11 is on standby to the light receiving device 13. The light receiving device 13 emits indicator light when the transmitted signal is received from display apparatus body 11.

The light receiving device 13 is attached to the central portion of the bottom surface 11b of the display apparatus body 11, and is laid out directly below the central portion of the bottom surface 11b. The light receiving device 13 may be laid out at a position other than directly below the central portion of the bottom surface 11b. For example, the light receiving device 13 may be laid out directly below the left end portion of the bottom surface 11b, directly below the right end portion of the bottom surface 11b, inside the bottom bezel of the display apparatus body 11, or the like.

### 1.2 Indicator Light

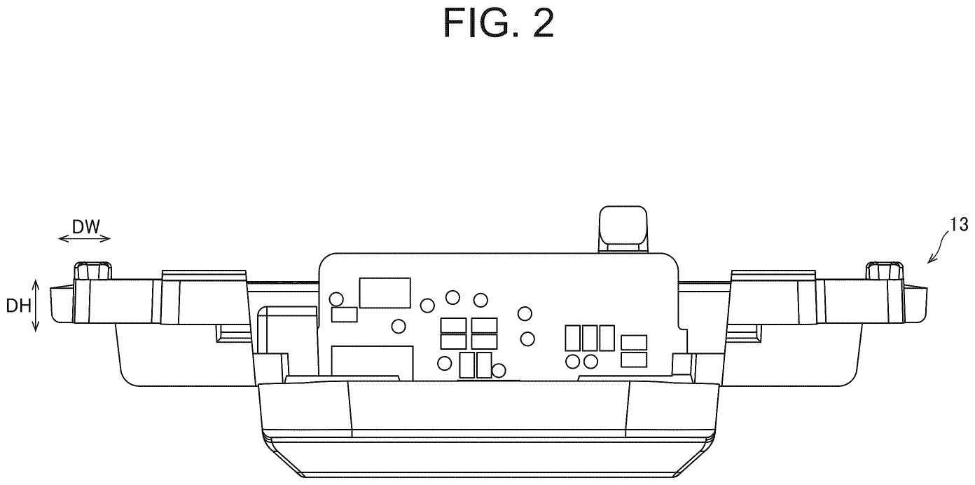

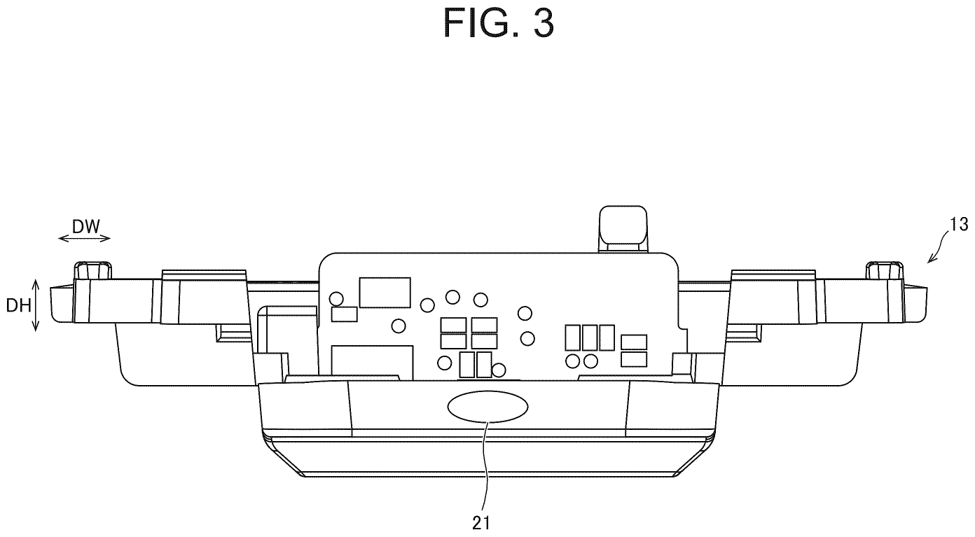

FIG. 2 is a front view schematically illustrating a state where the light receiving device provided in the display apparatus of the first embodiment does not emit indicator light. FIG. 3 is a front view schematically illustrating a state where the light receiving device provided in the display apparatus of the first embodiment emits indicator light.

When the display apparatus 1 is turned on and displays a video, as illustrated in FIG. 2, the light receiving device 13 is turned off and does not emit the indicator light. Thus, when the display apparatus 1 is turned on, it is possible to suppress the influence of the indicator light on the detection of the environmental light.

When the display apparatus 1 is on standby and does not display a video, as illustrated in FIG. 3, the light receiving device 13 is turned on and emits the indicator light 21. The indicator light 21 emitted is, for example, red light. The indicator light 21 may be light other than red light.

### 1.3 Light Receiving Device

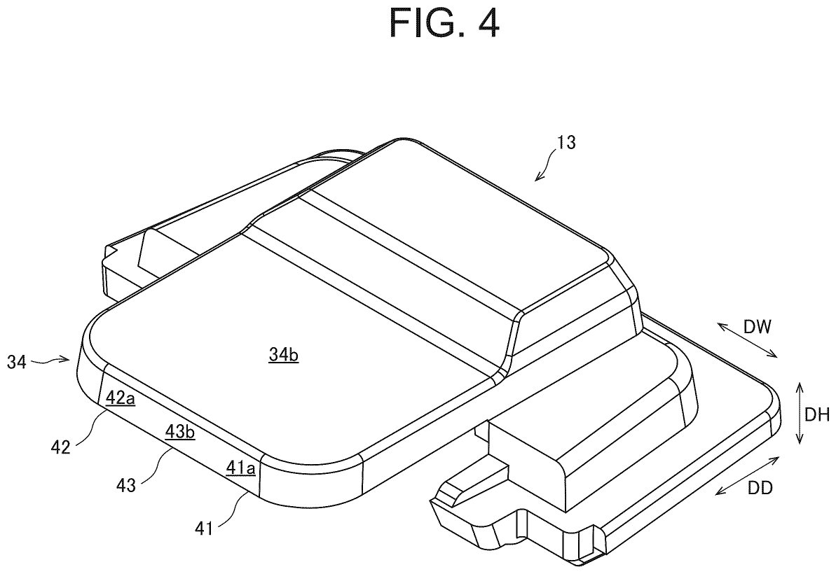

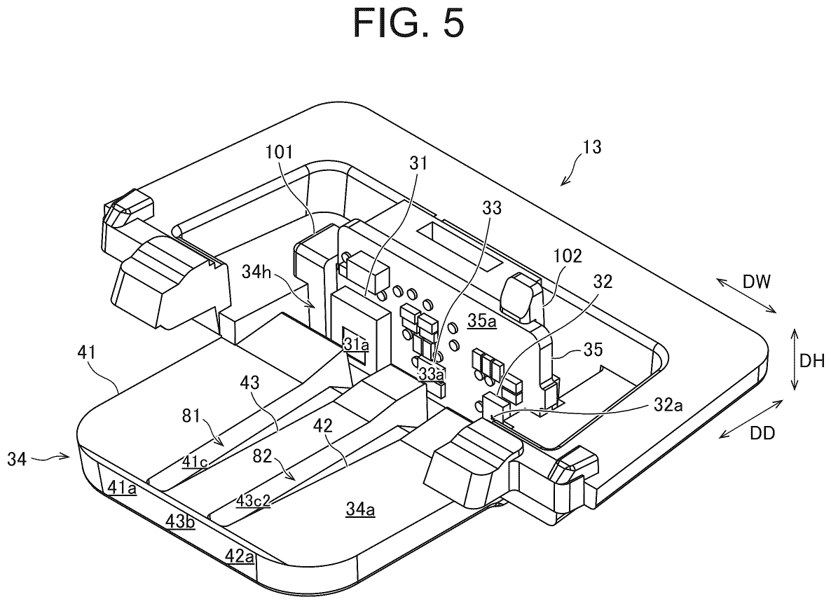

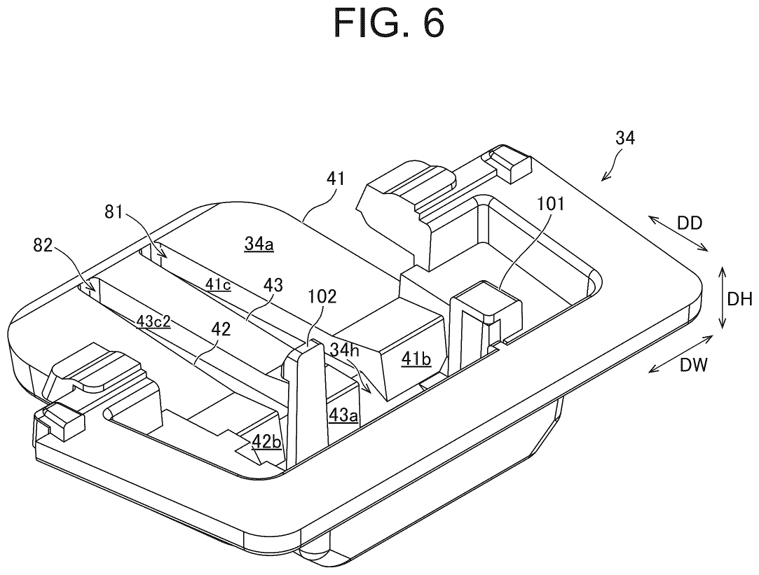

FIGS. 4 and 5 are perspective views schematically illustrating the light receiving device provided in the display apparatus of the first embodiment. FIG. 6 is a perspective view schematically illustrating a light guide provided in the display apparatus of the first embodiment.

As illustrated in FIGS. 4 to 6, the light receiving device 13 includes a first optical sensor 31, a second optical sensor 32, a light emitting element 33, a light guide 34, and a substrate 35. The light guide 34 includes a first lens 41, a second lens 42, and a third lens 43.

The first optical sensor 31 detects the remote control light.

The second optical sensor 32 detects the environmental light.

The light emitting element 33 emits the indicator light 21 when the display apparatus 1 is on standby and does not display a video. The indicator light 21 emitted is red light. Therefore, the light emitting element 33 is a red light emitting element. The light emitting element 33 is, for example, a light emitting diode.

The light guide 34 guides the remote control light and the environmental light from the outside of the light receiving device 13 to the first optical sensor 31 and the second optical sensor 32, respectively, and guides the indicator light 21 from the light emitting element 33 to the outside of the light receiving device 13. The light guide 34 is made of a transparent material, for example, a resin.

The substrate 35 supports the first optical sensor 31, the second optical sensor 32, and the light emitting element 33.

The first lens 41 has a first incidence surface 41a and a first emission surface 41b. The first optical sensor 31 has a first light receiving surface 31a. The first incidence surface 41a is disposed on the front side in the depth direction DD, and can be visually recognized from the front in the depth direction DD. The first emission surface 41b is disposed on the rear side in the depth direction DD and faces the rear in the depth direction DD. The first light receiving surface 31a is disposed behind the first emission surface 41b in the depth direction DD, faces the front in the depth direction DD, and faces the first emission surface 41b. Thus, the remote control light is incident on the first incidence surface 41a. The first lens 41 guides the incident remote control light from first incidence surface 41a to the first emission surface 41b. The first emission surface 41b emits the guided remote control light. The first light receiving surface 31a receives the emitted remote control light. Thus, the first lens 41 guides the incident remote control light to the first optical sensor 31. The first optical sensor 31 outputs a signal corresponding to the remote control light received by the first light receiving surface 31a. The incident remote control light includes infrared light. The first optical sensor 31 outputs a signal corresponding to the infrared light received by the first light receiving surface 31a.

The second lens 42 has a second incidence surface 42a and a second emission surface 42b. The second optical sensor 32 has a second light receiving surface 32a. The second incidence surface 42a is disposed on the front side in the depth direction DD, and can be visually recognized from the front in the depth direction DD. The second emission surface 42b is disposed on the rear side in the depth direction DD and faces the rear in the depth direction DD. The second light receiving surface 32a is disposed behind the second emission surface 42b in the depth direction DD, faces the front in the depth direction DD, and faces the second emission surface 42b. Thus, the environmental light is incident on the second incidence surface 42a. The second lens 42 guides the incident environmental light from the second incidence surface 42a to the second emission surface 42b. The second emission surface 42b emits the guided environmental light. The second light receiving surface 32a receives the emitted environmental light. Thus, the second lens 42 guides the incident environmental light to the second optical sensor 32. The second optical sensor 32 outputs a signal corresponding to the environmental light received by the second light receiving surface 32a. The incident environmental light includes visible light. The second optical sensor 32 outputs a signal corresponding to the visible light received by the second light receiving surface 32a.

The light emitting element 33 has a light emitting surface 33a. The third lens 43 has a third incidence surface 43a and a third emission surface 43b. The light emitting surface 33a faces the front in the depth direction DD and emits the indicator light 21. The third incidence surface 43a is disposed on the rear side in the depth direction DD, faces the rear in the depth direction DD, and faces the light emitting surface 33a. The third emission surface 43b is disposed on the front side in the depth direction DD, and can be visually recognized from the front in the depth direction DD. Thus, the emitted indicator light 21 is incident on the third incidence surface 43a. The third lens 43 guides the incident indicator light 21 from the third incidence surface 43a to the third emission surface 43b. The third emission surface 43b emits the guided indicator light 21.

The first optical sensor 31, the second optical sensor 32, and the light emitting element 33 are arrayed in a line in a width direction DW of the display apparatus 1. The first optical sensor 31 is disposed on the left side in the width direction DW when viewed from the front side in the depth direction DD. The second optical sensor 32 is disposed on the right side in the width direction DW when viewed from the front side in the depth direction DD. The light emitting element 33 is disposed at the center in the width direction DW when viewed from the front side in the depth direction DD. Therefore, the second optical sensor 32 and the light emitting element 33 are close to each other. As a result, the second optical sensor 32 receives part of the indicator light 21 emitted by the light emitting element 33. However, the light emitting element 33 does not emit the indicator light 21 during a period in which the display apparatus 1 is turned on and the signal output by the second optical sensor 32 is used for adjusting the video. Thus, it is possible to suppress the indicator light 21 from affecting the adjustment of the video. This effect is particularly remarkable when the light receiving device 13 is miniaturized or simplified and the amount of the indicator light 21 received by the second optical sensor 32 is increased.

### 1.4 Optical System for Remote Control Light

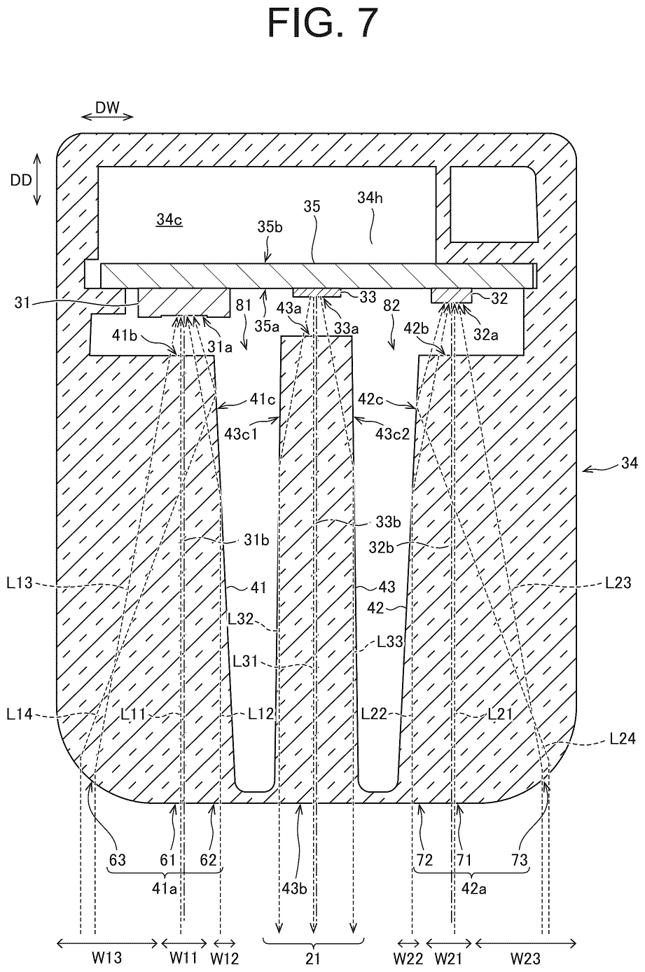

FIG. 7 is a cross-sectional view schematically illustrating the first optical sensor, the second optical sensor, the light emitting element, the light guide, and the substrate provided in the display apparatus of the first embodiment.

As illustrated in FIG. 7, the first optical sensor 31 has a first optical axis 31b. The first optical sensor 31 has directivity symmetrical with respect to the first optical axis 31b. For example, the sensitivity of the first optical sensor 31 is maximized in the direction in which the first optical axis 31b extends. The first optical axis 31b is perpendicular to the first light receiving surface 31a and passes through the center of first light receiving surface 31a.

The first incidence surface 41a includes a flat surface 61, a flat surface 62, and a convex curved surface 63.

An incident light ray L11 included in the remote control light is incident on the flat surface 61. The flat surface 61 is flat. The flat surface 61 is perpendicular to the first optical axis 31b. The flat surface 61 is disposed in a region on the first light receiving surface 31a. Therefore, the first optical axis 31b passes through the flat surface 61.

An incident light ray L12 included in the remote control light is incident on the flat surface 62. The flat surface 62 is flat. The flat surface 62 is adjacent to the flat surface 61. The flat surface 62 is flush with the flat surface 61. The flat surface 62 is disposed outside a region on the first light receiving surface 31a. The flat surface 62 is disposed to be shifted rightward in the width direction DW from a region on the first light receiving surface 31a when viewed from the front side in the depth direction DD. The flat surface 62 is perpendicular to the first optical axis 31b.

Incident light rays L13 and L14 included in the remote control light are incident on the convex curved surface 63. The convex curved surface 63 is curved in a convex shape and has an R shape. Therefore, the convex curved surface 63 has a positive power. As a result, the convex curved surface 63 condenses the incident light ray. The convex curved surface 63 is adjacent to the flat surface 61. The convex curved surface 63 is disposed outside a region on the first light receiving surface 31a. The convex curved surface 63 is disposed to be shifted leftward in the width direction DW from a region on the first light receiving surface 31a when viewed from the front side in the depth direction DD. The convex curved surface 63 is perpendicular to the first optical axis 31b at a right end portion close to the flat surface 61, and is smoothly connected to the flat surface 61. The convex curved surface 63 is parallel to the first optical axis 31b at a left end portion opposite to the right end portion close to the flat surface 61.

The first emission surface 41b emits the incident light rays L11, L12, L13, and L14. The first emission surface 41b is flat. The first emission surface 41b is disposed in a region on the first light receiving surface 31a. Therefore, the first optical axis 31b passes through the first emission surface 41b.

The first lens 41 has a first boundary surface 41c.

The first boundary surface 41c is disposed outside a region on the first light receiving surface 31a. The first boundary surface 41c is disposed to be shifted rightward in the width direction DW from a region on the first light receiving surface 31a when viewed from the front side in the depth direction DD. The first boundary surface 41c extends from the front side where the first incidence surface 41a is present to the rear side where the first emission surface 41b is present. The first boundary surface 41c is an inclined surface inclined from a direction parallel to the first optical axis 31b, faces an intermediate direction between the right side in the width direction DW and the rear side in the depth direction DD, and approaches the first optical axis 31b from the front side where the first incidence surface 41a is present toward the rear side where the first emission surface 41b is present.

When the incident light ray L11 travels in a direction parallel to first optical axis 31b until being incident on the first lens 41, the flat surface 61 transmits the incident light ray L11 toward the first emission surface 41b. The transmitted incident light ray L11 travels through the first lens 41 and reaches the first emission surface 41b. The first emission surface 41b emits the reached incident light ray L11 toward the first light receiving surface 31a. The first light receiving surface 31a receives the emitted incident light ray L11. The incident light ray L11 travels through a region on the first light receiving surface 31a when traveling through the first lens 41. Therefore, the incident light ray L11 does not reach the first boundary surface 41c disposed outside the region on the first light receiving surface 31a. As a result, the first boundary surface 41c does not hinder the first light receiving surface 31a from receiving the incident light ray L11.

When the incident light ray L12 travels in a direction parallel to first optical axis 31b until being incident on the first lens 41, the flat surface 62 transmits the incident light ray L12 toward the first boundary surface 41c. The transmitted incident light ray L12 travels through the first lens 41 and reaches the first boundary surface 41c. The first boundary surface 41c totally reflects the reached incident light ray L12 toward the first emission surface 41b. The totally reflected incident light ray L12 travels through the first lens 41 and reaches the first emission surface 41b. The first boundary surface 41c may reflect or diffuse the reached incident light ray L12 toward the first emission surface 41b. The reflected or diffused incident light ray L12 may travel through the first lens 41 and reach the first emission surface 41b. The first emission surface 41b emits the reached incident light ray L12 toward the first light receiving surface 31a. The first light receiving surface 31a receives the emitted incident light ray L12. Therefore, the first boundary surface 41c increases the amount of incident light ray received by the first light receiving surface 31a to enhance the light receiving efficiency of the light receiving device 13.

When the incident light rays L13 and L14 travel in a direction parallel to the first optical axis 31b until being incident on the first lens 41, the convex curved surface 63 refracts the incident light rays L13 and L14 toward the first emission surface 41b and the first boundary surface 41c, respectively. The incident light ray L13 refracted toward the first emission surface 41b travels through the first lens 41 and reaches the first emission surface 41b. The first emission surface 41b emits the reached incident light ray L13 toward the first light receiving surface 31a. The first light receiving surface 31a receives the emitted incident light ray L13. The incident light ray L14 refracted toward the first boundary surface 41c travels through the first lens 41 and reaches the first boundary surface 41c. The first boundary surface 41c totally reflects the reached incident light ray L14 toward the first emission surface 41b. The totally reflected incident light ray L14 travels through the first lens 41 and reaches the first emission surface 41b. The first boundary surface 41c may reflect or diffuse the reached incident light ray L14 toward the first emission surface 41b. The reflected or diffused incident light ray L14 may travel through the first lens 41 and reach the first emission surface 41b. The first emission surface 41b emits the reached incident light ray L14 toward the first light receiving surface 31a. The first light receiving surface 31a receives the emitted incident light ray L14. Therefore, the convex curved surface 63 increases the amount of incident light ray received by the first light receiving surface 31a to enhance the light receiving efficiency of the light receiving device 13.

As a whole, the first boundary surface 41c totally reflects the first light ray including the incident light rays L12 and L14 included in the remote control light toward the first emission surface 41b, thereby increasing the amount of the incident light ray received by the first light receiving surface 31a to enhance the light receiving efficiency of the light receiving device 13.

Hereinafter, the width of the first incidence surface 41a in the width direction DW is referred to as a width W1, the width of the first light receiving surface 31a and the flat surface 61 in the width direction DW is referred to as a width W11, the width of the first boundary surface 41c and the flat surface 62 in the width direction DW is referred to as a width W12, and the width of the convex curved surface 63 in the width direction DW is referred to as a width W13.

The width W12 of the flat surface 62 is preferably approximately one time the width W11 of the first light receiving surface 31a.

The width W13 of the convex curved surface 63 is preferably approximately twice the width W11 of the first light receiving surface 31a. In a case where the width W13 is significantly smaller than approximately twice the width W11, there is a tendency that fewer incident light rays enter the convex curved surface 63 and fewer light rays are condensed on the first light receiving surface 31a. Further, in a case where the width W13 is significantly smaller than approximately twice the width W11, there is a tendency that the focal point of the convex curved surface 63 is closer to the convex curved surface 63 and fewer light rays are condensed on the first light receiving surface 31a. On the other hand, in a case where the width W13 is significantly larger than approximately twice the width W11, there is a tendency that the convex curved surface 63 does not sufficiently condense the incident light rays and fewer light rays are condensed on the first light receiving surface 31a.

In a case where the width W12 of the flat surface 62 is approximately one time the width W11 of the first light receiving surface 31a, and the width W13 of the convex curved surface 63 is approximately twice the width W11 of the first light receiving surface 31a, the first lens 41 can condense, on the first light receiving surface 31a, an incident light ray incident on the first incidence surface 41a which has the width W1 that is approximately four times the width W11 of the first light receiving surface 31a. Thus, the light receiving efficiency of the light receiving device 13 can be enhanced. These effects can be confirmed by ray tracing simulation, measurement of a reaching range of remote control light in an actual machine, and the like. Enhancing the light receiving efficiency of the light receiving device 13 contributes to reducing the size of the light receiving device 13, increasing the reaching range of the remote control light, reducing the size of the first optical sensor 31, reducing the thickness of the light guide 34, and the like.

The amount of incident light ray condensed on the first light receiving surface 31a varies in a complex manner due to factors such as the position of the first boundary surface 41c, the width W13 of the convex curved surface 63, and the distance from the first incidence surface 41a to the first light receiving surface 31a. Therefore, in the light receiving device 13, these factors are adjusted in a balanced manner.

### 1.5 Optical System for Environmental Light

As illustrated in FIG. 7, the second optical sensor 32 has a second optical axis 32b. The second optical sensor 32 has directivity symmetrical with respect to the second optical axis 32b. For example, the sensitivity of the second optical sensor 32 is maximized in the direction in which the second optical axis 32b extends. The second optical axis 32b is perpendicular to the second light receiving surface 32a and passes through the center of second light receiving surface 32a.

As illustrated in FIG. 7, the second incidence surface 42a includes a flat surface 71, a flat surface 72, and a convex curved surface 73.

An incident light ray L21 included in the environmental light is incident on the flat surface 71. The flat surface 71 is flat. The flat surface 71 is perpendicular to the second optical axis 32b. The flat surface 71 is disposed in a region on the second light receiving surface 32a. Therefore, the second optical axis 32b passes through the flat surface 71.

An incident light ray L22 included in the environmental light is incident on the flat surface 72. The flat surface 72 is flat. The flat surface 72 is adjacent to the flat surface 71. The flat surface 72 is flush with the flat surface 71. The flat surface 72 is disposed outside a region on the second light receiving surface 32a. The flat surface 72 is disposed to be shifted leftward in the width direction DW from a region on the second light receiving surface 32a when viewed from the front side in the depth direction DD. The flat surface 72 is perpendicular to the second optical axis 32b.

Incident light rays L23 and L24 included in the environmental light are incident on the convex curved surface 73. The convex curved surface 73 is curved in a convex shape and has an R shape. Therefore, the convex curved surface 73 has a positive power. As a result, the convex curved surface 73 condenses the incident light ray. The convex curved surface 73 is adjacent to the flat surface 71. The convex curved surface 73 is disposed outside a region on the second light receiving surface 32a. The convex curved surface 73 is disposed to be shifted rightward in the width direction DW from a region on the second light receiving surface 32a when viewed from the front side in the depth direction DD. The convex curved surface 73 is perpendicular to the second optical axis 32b at a left end portion close to the flat surface 71, and is smoothly connected to the flat surface 71. The convex curved surface 73 is parallel to the second optical axis 32b at a right end portion opposite to the left end portion close to the flat surface 71.

The second emission surface 42b emits the incident light rays L21, L22, L23, and L24. The second emission surface 42b is flat. The second emission surface 42b is disposed in a region on the second light receiving surface 32a. Therefore, the second optical axis 32b passes through the second emission surface 42b.

The second lens 42 has a second boundary surface 42c.

The second boundary surface 42c is disposed outside a region on the second light receiving surface 32a. The second boundary surface 42c is disposed to be shifted leftward in the width direction DW from a region on the second light receiving surface 32a when viewed from the front side in the depth direction DD. The second boundary surface 42c extends from the front side where the second incidence surface 42a is present to the rear side where the second emission surface 42b is present. The second boundary surface 42c is an inclined surface inclined from a direction parallel to the second optical axis 32b, faces an intermediate direction between the left side in the width direction DW and the rear side in the depth direction DD, and approaches the second optical axis 32b from the front side where the second incidence surface 42a is present toward the rear side where the second emission surface 42b is present.

When the incident light ray L21 travels in a direction parallel to second optical axis 32b until being incident on the second lens 42, the flat surface 71 transmits the incident light ray L21 toward the second emission surface 42b. The transmitted incident light ray L21 travels through the second lens 42 and reaches the second emission surface 42b. The second emission surface 42b emits the reached incident light ray L21 toward the second light receiving surface 32a. The second light receiving surface 32a receives the emitted incident light ray L21. The incident light ray L21 travels through a region on the second light receiving surface 32a when traveling through the second lens 42. Therefore, the incident light ray L21 does not reach the second boundary surface 42c disposed outside the region on the second light receiving surface 32a. As a result, the second boundary surface 42c does not hinder the second light receiving surface 32a from receiving the incident light ray L21.

When the incident light ray L22 travels in a direction parallel to second optical axis 32b until being incident on the second lens 42, the flat surface 72 transmits the incident light ray L22 toward the second boundary surface 42c. The transmitted incident light ray L22 travels through the second lens 42 and reaches the second boundary surface 42c. The second boundary surface 42c totally reflects the reached incident light ray L22 toward the second emission surface 42b. The totally reflected incident light ray L22 travels through the second lens 42 and reaches the second emission surface 42b. The second boundary surface 42c may reflect or diffuse the reached incident light ray L22 toward the second emission surface 42b. The reflected or diffused incident light ray L22 may travel through the second lens 42 and reach the second emission surface 42b. The second emission surface 42b emits the reached incident light ray L22 toward the second light receiving surface 32a. The second light receiving surface 32a receives the emitted incident light ray L22. Therefore, the second boundary surface 42c increases the amount of incident light ray received by the second light receiving surface 32a to enhance the light receiving efficiency of the light receiving device 13.

When incident light rays L23 and L24 travel in a direction parallel to the second optical axis 32b until being incident on the second lens 42, the convex curved surface 73 refracts the incident light rays L23 and L24 toward the second emission surface 42b and the second boundary surface 42c, respectively. The incident light ray L23 refracted toward the second emission surface 42b travels through the second lens 42 and reaches the second emission surface 42b. The second emission surface 42b emits the reached incident light ray L23 toward the second light receiving surface 32a. The second light receiving surface 32a receives the emitted incident light ray L23. The incident light ray L24 refracted toward the second boundary surface 42c travels through the second lens 42 and reaches the second boundary surface 42c. The second boundary surface 42c totally reflects the reached incident light ray L24 toward the second emission surface 42b. The totally reflected incident light ray L24 travels through the second lens 42 and reaches the second emission surface 42b. The second boundary surface 42c may reflect or diffuse the reached incident light ray L24 toward the second emission surface 42b. The reflected or diffused incident light ray L24 travels through the second lens 42 and reaches the second emission surface 42b. The second emission surface 42b emits the reached incident light ray L24 toward the second light receiving surface 32a. The second light receiving surface 32a receives the emitted incident light ray L24. Therefore, the convex curved surface 73 increases the amount of incident light ray received by the second light receiving surface 32a to enhance the light receiving efficiency of the light receiving device 13.

As a whole, the second boundary surface 42c totally reflects the second light ray including the incident light rays L22 and L24 included in the environmental light toward the second emission surface 42b, thereby increasing the amount of the incident light ray received by the second light receiving surface 32a to enhance the light receiving efficiency of the light receiving device 13.

Hereinafter, the width of the second incidence surface 42a in the width direction DW is referred to as a width W2, the width of the second light receiving surface 32a and the flat surface 71 in the width direction DW is referred to as a width W21, the width of the second boundary surface 42c and the flat surface 72 in the width direction DW is referred to as a width W22, and the width of the convex curved surface 73 in the width direction DW is referred to as a width W23.

The width W22 of the flat surface 72 is preferably approximately one time the width W21 of the second light receiving surface 32a.

The width W23 of the convex curved surface 73 is preferably approximately twice the width W21 of the second light receiving surface 32a. The reason for this is the same as the reason why the width W13 of the convex curved surface 63 is preferably approximately twice the width W11 of the first light receiving surface 31a.

In a case where the width W22 of the flat surface 72 is approximately one time the width W21 of the second light receiving surface 32a, and the width W23 of the convex curved surface 73 is approximately twice the width W21 of the second light receiving surface 32a, the second lens 42 can condense, on the second light receiving surface 32a, an incident light ray incident on the second incidence surface 42a which has the width W2 that is approximately four times the width W21 of the second light receiving surface 32a. Thus, the light receiving efficiency of the light receiving device 13 can be enhanced. These effects can be confirmed by ray tracing simulation, measurement of a reaching range of remote control light in an actual machine, and the like. Enhancing the light receiving efficiency of the light receiving device 13 contributes to reducing the size of the light receiving device 13, reducing the size of the second optical sensor 32, reducing the thickness of the light guide 34, and the like.

The amount of incident light ray condensed on the second light receiving surface 32a varies in a complex manner due to factors such as the position of the second boundary surface 42c, the width W23 of the convex curved surface 73, and the distance from the second incidence surface 42a to the second light receiving surface 32a. Therefore, in the light receiving device 13, these factors are adjusted in a balanced manner.

### 1.6 Optical System for Indicator Light

As illustrated in FIG. 7, the light emitting element 33 has a third optical axis 33b. The light emitting element 33 has directivity symmetrical with respect to the third optical axis 33b. For example, the emission intensity of the light emitting element 33 is maximized in the direction in which the third optical axis 33b extends. The third optical axis 33b is perpendicular to the light emitting surface 33a and passes through the center of the light emitting surface 33a.

Emission light rays L31, L32, and L33 included in the indicator light 21 are incident on the third incidence surface 43a. The emission light ray L31 travels in a direction parallel to the third optical axis 33b. The emission light ray L32 travels in a direction inclined leftward in the width direction DW from a direction parallel to the third optical axis 33b. The emission light ray L33 travels in a direction inclined rightward in the width direction DW from a direction parallel to the third optical axis 33b. The third incidence surface 43a is flat. The third incidence surface 43a is perpendicular to the third optical axis 33b. The third incidence surface 43a is disposed in a region including a region on the light emitting surface 33a. Therefore, the third optical axis 33b passes through the third incidence surface 43a.

The third emission surface 43b emits the emission light rays L31, L32, and L33. The third emission surface 43b is flat. The third emission surface 43b is perpendicular to the third optical axis 33b. The third emission surface 43b is disposed in a region including a region on the light emitting surface 33a. Therefore, the third optical axis 33b passes through the third emission surface 43b.

As illustrated in FIG. 7, the third lens 43 has third boundary surfaces 43c1 and 43c2.

The third boundary surface 43c1 is disposed outside a region on the light emitting surface 33a. The third boundary surface 43c1 is disposed to be shifted leftward in the width direction DW from a region on the light emitting surface 33a when viewed from the front side in the depth direction DD. The third boundary surface 43c1 extends from the front side where the third emission surface 43b is present to the rear side where the third incidence surface 43a is present. The third boundary surface 43c1 is an inclined surface inclined from a direction parallel to the third optical axis 33b, faces an intermediate direction between the left side in the width direction DW and the rear side in the depth direction DD, and approaches the third optical axis 33b from the front side where the third emission surface 43b is present toward the rear side where the third incidence surface 43a is present.

The third boundary surface 43c2 is disposed outside a region on the light emitting surface 33a. The third boundary surface 43c2 is disposed to be shifted rightward in the width direction DW from a region on the light emitting surface 33a when viewed from the front side in the depth direction DD. The third boundary surface 43c2 extends from the front side where the third emission surface 43b is present to the rear side where the third incidence surface 43a is present. The third boundary surface 43c2 is an inclined surface inclined from a direction parallel to the third optical axis 33b, faces an intermediate direction between the right side in the width direction DW and the rear side in the depth direction DD, and approaches the third optical axis 33b from the front side where the third emission surface 43b is present toward the rear side where the third incidence surface 43a is present.

The third incidence surface 43a transmits the emission light ray L31 toward the third emission surface 43b. The transmitted emission light ray L31 travels through the third lens 43 and reaches the third emission surface 43b. The third emission surface 43b emits the reached emission light ray L31.

The third incidence surface 43a transmits the emission light ray L32 toward the third boundary surface 43c1. The transmitted emission light ray L32 travels through the third lens 43 and reaches the third boundary surface 43c1. The third boundary surface 43c1 totally reflects the reached emission light ray L32 toward the third emission surface 43b. The totally reflected emission light ray L32 travels through the third lens 43 and reaches the third emission surface 43b. The third emission surface 43b emits the reached emission light ray L32. The third boundary surface 43c1 may reflect or diffuse the reached emission light ray L32 toward the third emission surface 43b. The reflected or diffused emission light ray L32 may travel through the third lens 43 and reach the third emission surface 43b.

The third incidence surface 43a transmits the emission light ray L33 toward the third boundary surface 43c2. The transmitted emission light ray L33 travels through the third lens 43 and reaches the third boundary surface 43c2. The third boundary surface 43c2 totally reflects the reached emission light ray L33 toward the third emission surface 43b. The totally reflected emission light ray L33 travels through the third lens 43 and reaches the third emission surface 43b. The third boundary surface 43c2 may reflect or diffuse the reached emission light ray L33 toward the third emission surface 43b. The reflected or diffused emission light ray L33 may travel through the third lens 43 and reach the third emission surface 43b. The third emission surface 43b emits the reached emission light ray L33.

As a whole, the third boundary surfaces 43c1 and 43c2 totally reflect, toward the third emission surface 43b, a third light ray including the emission light rays L32 and L33 included in the indicator light 21 emitted by the light emitting element 33.

### 1.7 Formation of Slit in the Light Guide

As illustrated in FIGS. 5 to 7, a first slit 81 and a second slit 82 are formed in the light guide 34.

The light guide 34 has a plate-like shape. Therefore, the light guide 34 has a main surface 34a and a main surface 34b. The main surface 34a is disposed on the upper side in the height direction DH. The main surface 34b is disposed on the lower side in the height direction DH. The first slit 81 and the second slit 82 are formed in the main surface 34a. The first slit 81 and the second slit 82 have a groove-like shape. The first slit 81 and the second slit 82 may be formed in the main surface 34b, or may be formed to be distributed in the main surface 34a and the main surface 34b.

The first slit 81 is formed between the first lens 41 and the third lens 43. The second slit 82 is formed between the second lens 42 and the third lens 43.

The first boundary surface 41c and the third boundary surface 43c1 face the first slit 81. The first boundary surface 41c and the third boundary surface 43c1 sandwich the first slit 81 from the left side and the right side in the width direction DW, and constitute inner side surfaces of the first slit 81.

The second boundary surface 42c and the third boundary surface 43c2 face the second slit 82. The second boundary surface 42c and the third boundary surface 43c2 sandwich the second slit 82 from the right side and the left side in the width direction DW, and constitute inner side surfaces of the second slit 82.

### 1.8 Fixation of Substrate to Light Guide

As illustrated in FIGS. 5 and 7, the substrate 35 has a first main surface 35a and a second main surface 35b.

The first main surface 35a and the second main surface 35b are on opposite sides. The first main surface 35a is disposed on the front side in the depth direction DD and faces the front in the depth direction DD. The first optical sensor 31, the second optical sensor 32, and the light emitting element 33 are mounted on the first main surface 35a. The second main surface 35b is disposed on the rear side in the depth direction DD and faces the rear in the depth direction DD.

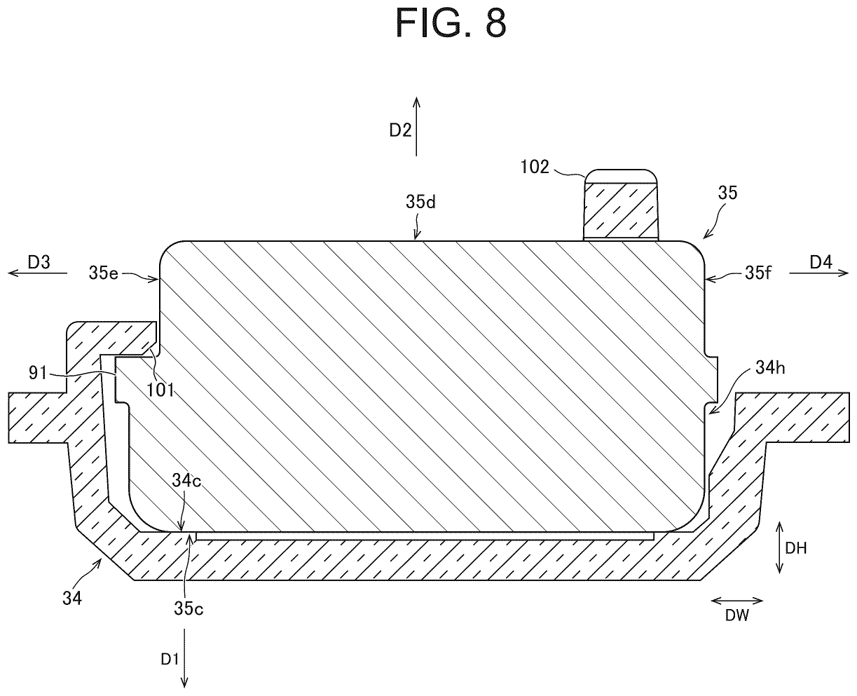

FIG. 8 is a cross-sectional view schematically illustrating the light guide and the substrate provided in the display apparatus of the first embodiment.

As illustrated in FIG. 8, the substrate 35 has a rectangular plate-like shape. Therefore, the substrate 35 has a first end surface 35c, a second end surface 35d, a third end surface 35e, and a fourth end surface 35f.

The first end surface 35c and the second end surface 35d are on opposite sides. The third end surface 35e and the fourth end surface 35f are on opposite sides. The first end surface 35c faces a first direction D1. The second end surface 35d faces a second direction D2 opposite to the first direction D1. The third end surface 35e faces a third direction D3 intersecting the first direction D1 and the second direction D2. The fourth end surface 35f faces a fourth direction D4 that intersects the first direction D1 and the second direction D2 and is opposite to the third direction D3. The third direction D3 and the fourth direction D4 are perpendicular to the first direction D1 and the second direction D2. A protrusion 91 is formed on the third end surface 35e.

A hole 34h is formed in the light guide 34. Thus, the light guide 34 has an inner bottom surface 34c facing the hole 34h. The inner bottom surface 34c faces upward in the height direction DH.

As illustrated in FIGS. 5, 6, and 8, the light guide 34 includes a stopper 101 and a hook 102.

The stopper 101 has a hook-like shape. The stopper 101 is separated upward from the inner bottom surface 34c in the height direction DH by a first distance. The hook 102 is separated upward from the inner bottom surface 34c in the height direction DH by a second distance that is longer than the first distance.

The substrate 35 is housed in the hole 34h. In a state where the substrate 35 is housed in the hole 34h, the first end surface 35c abuts on the inner bottom surface 34c. Thus, the substrate 35 is restricted from moving downward in the height direction DH.

In addition, in a state where the substrate 35 is housed in the hole 34h, the protrusion 91 abuts on the stopper 101 from the rear side in the depth direction DD, and the protrusion 91 abuts on the stopper 101 from the lower side in the height direction DH. Thus, the substrate 35 is restricted from moving upward in the height direction DH and forward in the depth direction DD.

In addition, in a state where the substrate 35 is housed in the hole 34h, the second main surface 35b abuts on the hook 102 from the front side in the depth direction DD, and the second end surface 35d abuts on the hook 102 from the lower side in the height direction DH. Thus, the substrate 35 is restricted from moving upward in the height direction DH and rearward in the depth direction DD.

With these, the substrate 35 is fixed to the light guide 34.

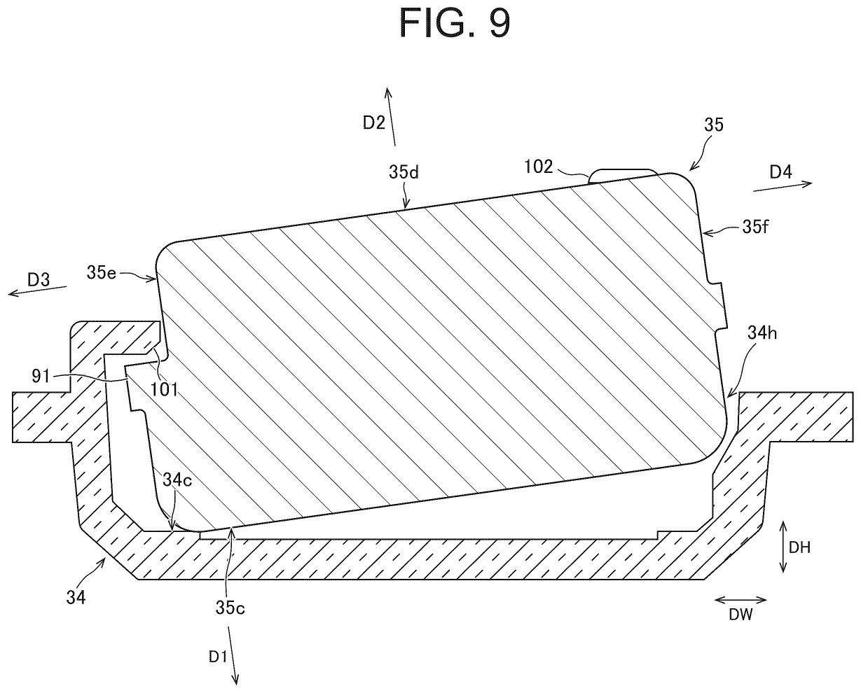

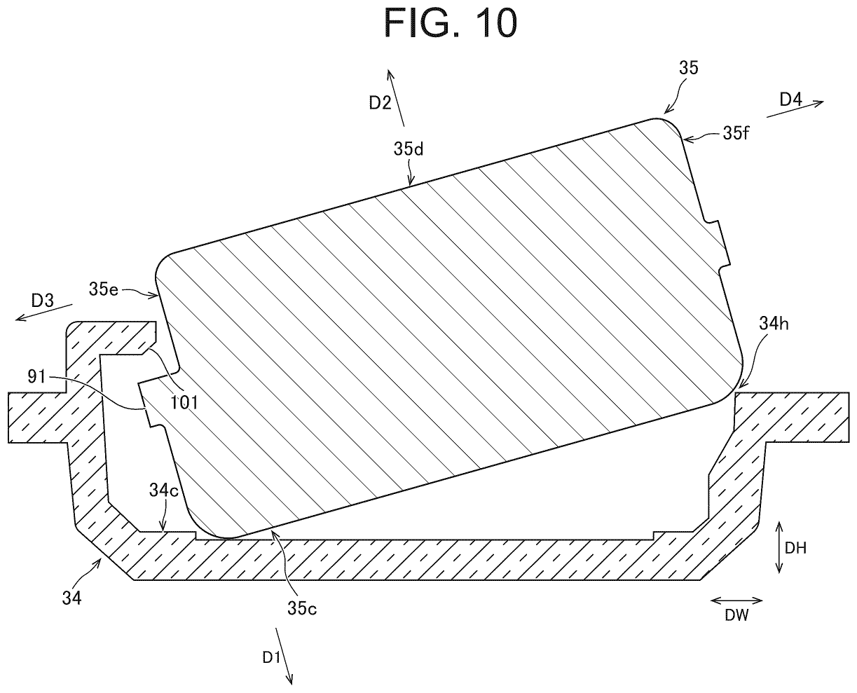

FIGS. 9 and 10 are cross-sectional views schematically illustrating a state of the light guide and the substrate provided in the display apparatus of the first embodiment in the middle of fixing the substrate to the light guide.

When the substrate 35 is fixed to the light guide 34, the hook 102 is elastically deformed rearward in the depth direction DD. In addition, as illustrated in FIG. 9, the substrate 35 is inserted into the hole 34h in a state where the substrate 35 is inclined in such a manner that the protrusion 91 is disposed below the stopper 101 in the height direction DH. Further, as illustrated in FIGS. 10 and 8, the substrate 35 is rotated until the first end surface 35c abuts on the inner bottom surface 34c. When the substrate 35 is rotated until the first end surface 35c abuts on the inner bottom surface 34c, the elastically deformed hook 102 returns to the original position. Thus, the substrate 35 is fixed to the light guide 34.

### 1.9 Simulation

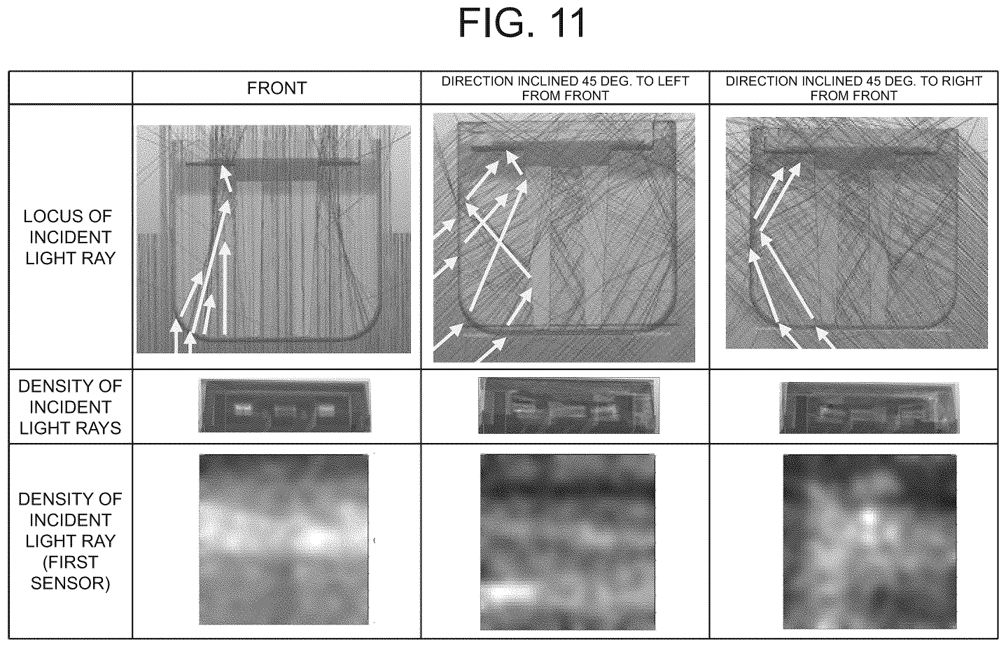

FIG. 11 are images illustrating a locus of an incident light ray included in the remote control light incident on the light receiving device provided in the display apparatus of the first embodiment, a distribution of density of incident light rays reaching the first optical sensor, the second optical sensor, the light emitting element, and the substrate provided in the light receiving device, and a distribution of density of incident light rays reaching the first sensor.

In FIG. 11, the image of the first row illustrates the locus of the incident light ray, the image of the second row illustrates the distribution of density of incident light rays reaching the first optical sensor 31, the second optical sensor 32, the light emitting element 33, and the substrate 35, and the image of the third row enlarges and illustrates the distribution of density of the incident light rays reaching the first optical sensor 31. In FIG. 11, the image of the first row illustrates the result of a simulation when the incident light ray is incident on the light receiving device 13 from the front in the depth direction DD, the image of the second row illustrates the result of a simulation when the incident light ray is incident on the light receiving device 13 from a direction inclined 45 degrees to the left in the width direction DW from the front in the depth direction DD, and the image of the third row illustrates the result of a simulation when the incident light ray is incident on the light receiving device 13 from a direction inclined 45 degrees to the right in the width direction DW from the front in the depth direction DD. The distribution of the density of the incident light rays is expressed in such a manner that the color at the position of interest becomes closer to white as the density of the incident light ray at the position of interest increases.

As illustrated in FIG. 11, the light guide 34 can most efficiently guide the incident light ray to the first optical sensor 31 when the incident light ray is incident on the light receiving device 13 from the front in the depth direction DD, and can efficiently guide the incident light ray to the first optical sensor 31 even when the incident light ray is incident on the light receiving device 13 from a direction inclined by 45 degrees from the front in the depth direction DD. The reason why the light guide 34 can efficiently guide the incident light ray to the first optical sensor 31 even in the latter case is that the light guide 34 can guide the incident light ray to the first optical sensor 31 by the total reflection by the first boundary surface 41c, the light collection by the convex curved surface 63, and the total reflection by an outer peripheral surface other than the first boundary surface 41c. Thus, the light receiving device 13 has the highest light receiving efficiency when the remote control light arrives from the front, which occurs most frequently, and has high light receiving efficiency even when the remote control light arrives from other than the front. For example, in an actual machine of the light receiving device 13, it is possible to achieve a remote control reaching range equal to or longer than 20 m, which is longer than a conventional remote control reaching range of approximately 10 m.

### 2. Second Embodiment

Hereinafter, differences between a second embodiment and the first embodiment will be described. The second embodiment adopts the same configuration as the first embodiment for points that are not described.

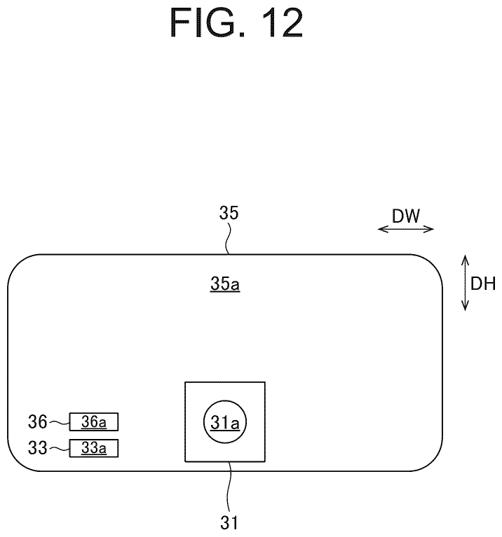

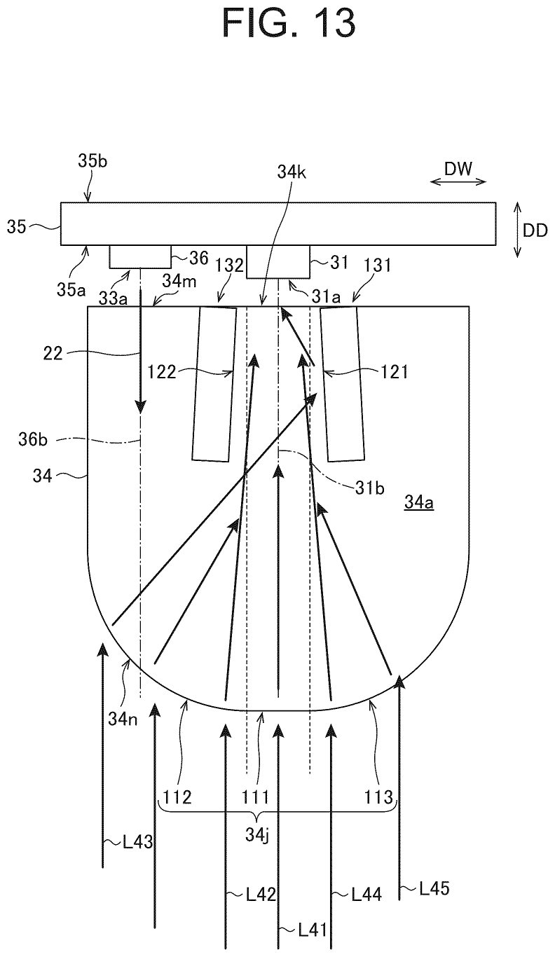

FIG. 12 is a front view schematically illustrating a first optical sensor, a light emitting element, and a substrate provided in a display apparatus of a second embodiment. FIG. 13 is a top view schematically illustrating the first optical sensor, the light emitting element, a light guide, and the substrate provided in the display apparatus of the second embodiment.

In the second embodiment, as illustrated in FIGS. 12 and 13, the light receiving device 13 includes the first optical sensor 31, the light emitting element 33, and a light emitting element 36, but does not include the second optical sensor 32.

The first optical sensor 31 is disposed at the center in the width direction DW. The light emitting elements 33 and 36 are disposed on the left side in the width direction DW.

The light emitting element 36 emits the indicator light 22 when the display apparatus 1 is turned on and displays a video. The indicator light 22 emitted is green light. Therefore, the light emitting element 36 is a green light emitting element. The light emitting element 33 is, for example, a light emitting diode.

In addition, in the second embodiment, as illustrated in FIG. 13, the light guide 34 has an incidence surface 34j, an emission surface 34k, an incidence surface 34m, and an emission surface 34n.

The incidence surface 34j is disposed on the front side in the depth direction DD, and can be visually recognized from the front in the depth direction DD. The emission surface 34k is disposed on the rear side in the depth direction DD and faces the rear in the depth direction DD. The first light receiving surface 31a is disposed behind the emission surface 34k in the depth direction DD, faces the front in the depth direction DD, and faces the emission surface 34k. Thus, the remote control light is incident on the incidence surface 34j. The light guide 34 guides the incident remote control light from the incidence surface 34j to the emission surface 34k. The emission surface 34k emits the guided remote control light. The first light receiving surface 31a receives the emitted remote control light. Thus, the light guide 34 guides the incident remote control light to the first optical sensor 31. A part of the incidence surface 34j also serves as the emission surface 34n.

The light emitting elements 33 and 36 have light emitting surfaces 33a and 36a, respectively. The light emitting surfaces 33a and 36a face the front in the depth direction DD and emit the indicator lights 21 and 22, respectively. The incidence surface 34m is disposed on the rear side in the depth direction DD, faces the rear in the depth direction DD, and faces the light emitting surfaces 33a and 36a. The emission surface 34n is disposed on the front side in the depth direction DD, and can be visually recognized from the front in the depth direction DD. Thus, the emitted indicator light 21 and 22 is incident on the incidence surface 34m. The light guide 34 guides the incident indicator light 21 and 22 from the incidence surface 34m to the emission surface 34n. The emission surface 34n emits the guided indicator light 21 and 22.

The incidence surface 34j includes a flat surface 111, a convex curved surface 112, and an other convex curved surface 113.

An incident light ray L41 included in the remote control light is incident on the flat surface 111. The flat surface 111 is flat. The flat surface 111 is perpendicular to the first optical axis 31b. The flat surface 111 is disposed in a region on the first light receiving surface 31a. Therefore, the first optical axis 31b passes through the flat surface 111.

Incident light rays L42 and L43 included in the remote control light are incident on the convex curved surface 112. The convex curved surface 112 is curved in a convex shape and has an R shape. Therefore, the convex curved surface 112 has a positive power. As a result, the convex curved surface 112 condenses the incident light ray. The convex curved surface 112 is adjacent to the flat surface 111. The convex curved surface 112 is disposed outside a region on the first light receiving surface 31a. The convex curved surface 112 is disposed to be shifted leftward in the width direction DW from a region on the first light receiving surface 31a when viewed from the front in the depth direction DD. The convex curved surface 112 is perpendicular to the first optical axis 31b at a right end portion close to the flat surface 111, and is smoothly connected to the flat surface 111. The convex curved surface 112 is parallel to the first optical axis 31b at a left end portion opposite to the right end portion close to the flat surface 111.

The other convex curved surface 113 is curved in a convex shape and has an R shape. Therefore, the other convex curved surface 113 has a positive power. As a result, the other convex curved surface 113 condenses the other incident light ray. The other convex curved surface 113 is adjacent to the flat surface 111. The other convex curved surface 113 is disposed outside a region on the first light receiving surface 31a. The other convex curved surface 113 is disposed to be shifted rightward in the width direction DW from a region on the first light receiving surface 31a when viewed from the front in the depth direction DD. The other convex curved surface 113 is perpendicular to the first optical axis 31b at a left end portion close to the flat surface 111, and is smoothly connected to the flat surface 111. The other convex curved surface 113 is parallel to the first optical axis 31b at a right end portion opposite to the left end portion close to the flat surface 111.

The light guide 34 has a boundary surface 121 and an other boundary surface 122.

The boundary surface 121 is disposed outside a region on the first light receiving surface 31a. The boundary surface 121 is disposed to be shifted rightward in the width direction DW from a region on the first light receiving surface 31a when viewed from the front in the depth direction DD. The boundary surface 121 extends from the front side where the incidence surface 34j is present to the rear side where the emission surface 34k is present. The boundary surface 121 is an inclined surface inclined from a direction parallel to the first optical axis 31b, faces an intermediate direction between the right side in the width direction DW and the rear side in the depth direction DD, and approaches the first optical axis 31b from the front side where the incidence surface 34j is present toward the rear side where the emission surface 34k is present.

The other boundary surface 122 is disposed outside a region on the first light receiving surface 31a. The other boundary surface 122 is disposed to be shifted leftward in the width direction DW from a region on the first light receiving surface 31a when viewed from the front in the depth direction DD. The other boundary surface 122 extends from the front side where the incidence surface 34j is present to the rear side where the emission surface 34k is present. The other boundary surface 122 is an inclined surface inclined from a direction parallel to the first optical axis 31b, faces an intermediate direction between the left side in the width direction DW and the rear side in the depth direction DD, and approaches the first optical axis 31b from the front side where the incidence surface 34j is present toward the rear side where the emission surface 34k is present.

When the incident light ray L41 travels in a direction parallel to first optical axis 31b until being incident on the light guide 34, the flat surface 111 transmits the incident light ray L41 toward the emission surface 34k. The transmitted incident light ray L41 travels through the light guide 34 and reaches the emission surface 34k. The emission surface 34k emits the reached incident light ray L41 toward the first light receiving surface 31a. The first light receiving surface 31a receives the emitted incident light ray L41. The incident light ray L41 travels through a region on the first light receiving surface 31a when traveling through the light guide 34. Therefore, the incident light ray L41 does not reach the boundary surface 121 and the other boundary surface 122, which are disposed outside the region on the first light receiving surface 31a. As a result, the boundary surface 121 and the other boundary surface 122 do not hinder the first light receiving surface 31a from receiving the incident light ray L41.

When the incident light rays L42 and L43 travel in a direction parallel to the first optical axis 31b until being incident on the light guide 34, the convex curved surface 112 refracts the incident light rays L42 and L43 toward the emission surface 34k and the boundary surface 121, respectively. The incident light ray L42 refracted toward the emission surface 34k travels through the light guide 34 and reaches the emission surface 34k. The emission surface 34k emits the reached incident light ray L42 toward the first light receiving surface 31a. The first light receiving surface 31a receives the emitted incident light ray L42. The incident light ray L43 refracted toward the boundary surface 121 travels through the light guide 34 and reaches the boundary surface 121. The boundary surface 121 totally reflects the reached incident light ray L43 toward the emission surface 34k. The totally reflected incident light ray L43 travels through the light guide 34 and reaches the emission surface 34k. The boundary surface 121 may reflect or diffuse the reached incident light ray L43 toward the emission surface 34k. The reflected or diffused incident light ray L43 may travel through the light guide 34 and reach the emission surface 34k. The emission surface 34k emits the reached incident light ray L43 toward the first light receiving surface 31a. The first light receiving surface 31a receives the emitted incident light ray L43. Therefore, the convex curved surface 112 increases the amount of incident light ray received by the first light receiving surface 31a to enhance the light receiving efficiency of the light receiving device 13.

When other incident light rays L44 and L45 travel in a direction parallel to the first optical axis 31b until being incident on the light guide 34, the other convex curved surface 113 refracts the incident light rays L44 and L45 toward the emission surface 34k and the other boundary surface 122, respectively. The other incident light ray L44 refracted toward the emission surface 34k travels through the light guide 34 and reaches the emission surface 34k. The emission surface 34k emits the reached other incident light ray L44 toward the first light receiving surface 31a. The first light receiving surface 31a receives the emitted incident light ray L44. The other incident light ray L45 refracted toward the other boundary surface 122 travels through the light guide 34 and reaches the other boundary surface 122. The other boundary surface 122 totally reflects the reached other incident light ray L45 toward the emission surface 34k. The totally reflected other incident light ray L45 travels through the light guide 34 and reaches the emission surface 34k. The other boundary surface 122 may reflect or diffuse the reached other incident light ray L45 toward the emission surface 34k. The reflected or diffused incident light ray L45 may travel through the light guide 34 and reach the emission surface 34k. The emission surface 34k emits the reached other incident light ray L45 toward the first light receiving surface 31a. The first light receiving surface 31a receives the emitted incident light ray L45. Therefore, the other convex curved surface 113 increases the amount of incident light ray received by the first light receiving surface 31a to enhance the light receiving efficiency of the light receiving device 13.

In the second embodiment, the two convex curved surfaces including the convex curved surface 112 and the other convex curved surface 113 increase the amount of the incident light ray received by the first light receiving surface 31a. Therefore, in the second embodiment, the amount of incident light ray received by the first light receiving surface 31a can be increased more effectively than in the case where one convex curved surface increases the amount of incident light ray received by the first light receiving surface 31a.

A slit 131 and an other slit 132 are formed in the light guide 34.

The boundary surface 121 and the other boundary surface 122 face the slit 131 and the other slit 132, respectively.

The emitted indicator light 21 and 22 is incident on the incidence surface 34m. The incidence surface 34m is flat. The incidence surface 34m is perpendicular to the third optical axis 33b. The incidence surface 34m is disposed in a region on the light emitting surface 33a. Therefore, the third optical axis 33b passes through the incidence surface 34m.

The emission surface 34n emits the indicator light 21 and 22. The emission surface 34n is disposed in a region on the light emitting surface 33a. Therefore, the third optical axis 33b passes through the emission surface 34n.

### 3. Third Embodiment

Hereinafter, differences between a third embodiment and the second embodiment will be described. The third embodiment adopts the same configuration as the second embodiment for points that are not described.

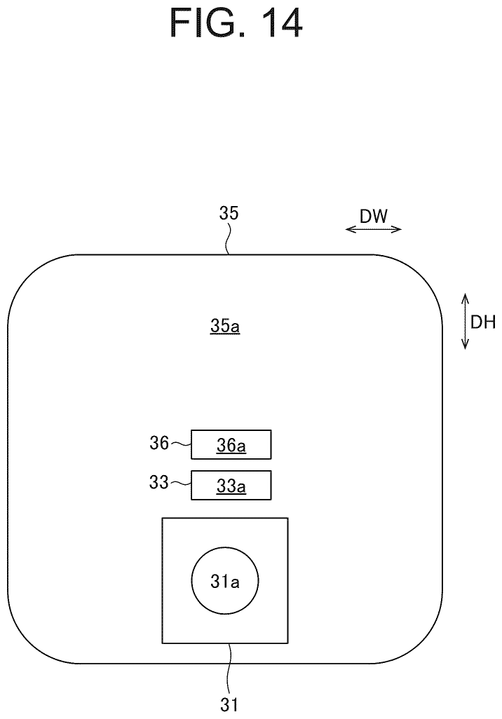

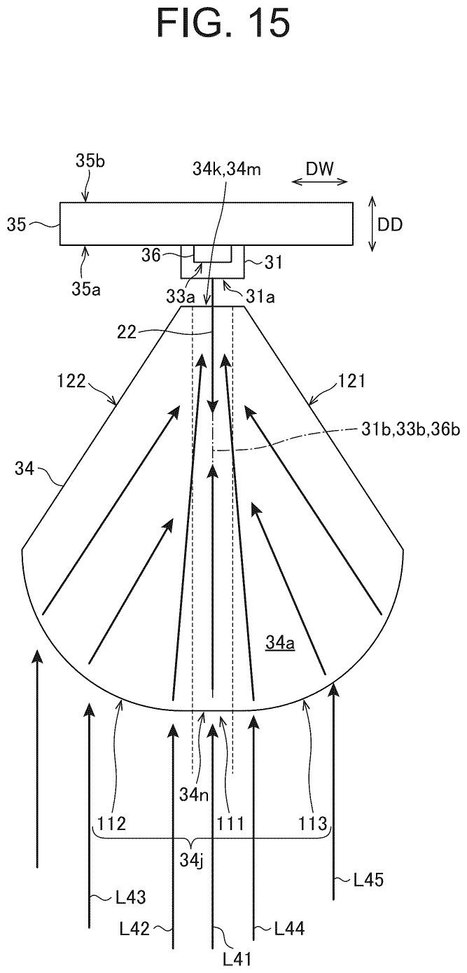

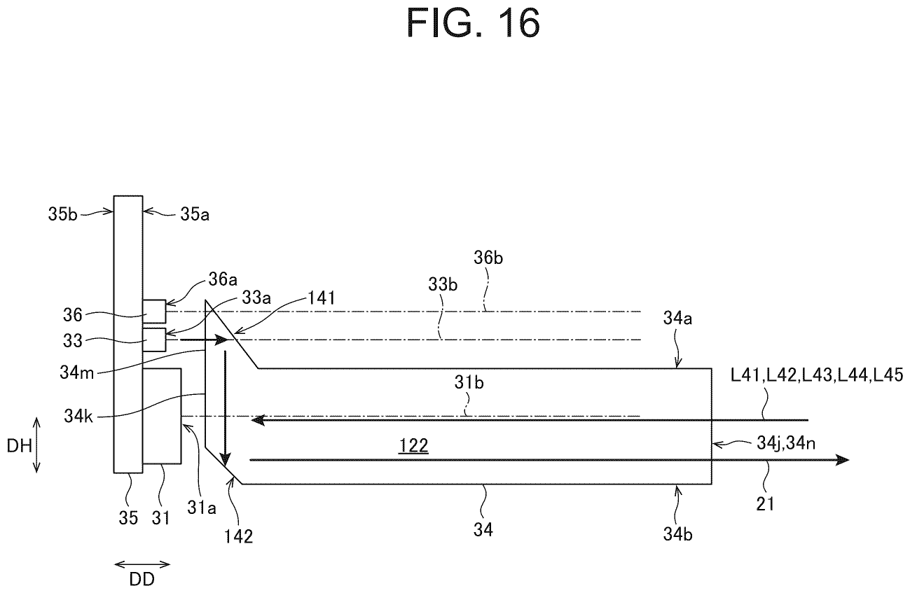

FIG. 14 is a front view schematically illustrating a first optical sensor, a light emitting element, and a substrate provided in a display apparatus of a third embodiment. FIG. 15 is a top view schematically illustrating the first optical sensor, the light emitting element, a light guide, and the substrate provided in the display apparatus of the third embodiment. FIG. 16 is a side view schematically illustrating the first optical sensor, the light emitting element, the light guide, and the substrate provided in the display apparatus of the third embodiment.

In the third embodiment, the first optical sensor 31, the light emitting element 33, and the light emitting element 36 are disposed at the center in the width direction DW.

In the third embodiment, the light guide 34 has boundary surfaces 141 and 142.

The boundary surfaces 141 and 142 are disposed at the same position in the depth direction DD and the width direction DW, and are disposed at positions different from each other in the height direction DH. The boundary surface 141 totally reflects the indicator light 21 and 22 incident on the incidence surface 34m toward the boundary surface 142. The boundary surface 142 totally reflects the totally reflected indicator light 21 and 22 toward the emission surface 34n.

The boundary surface 121 and the other boundary surface 122 do not face the slit. The boundary surface 121 and the other boundary surface 122 may face the slit formed in the light guide 34.

In the third embodiment, similarly to the second embodiment, the two convex curved surfaces including the convex curved surface 112 and the other convex curved surface 113 increase the amount of the incident light ray received by the first light receiving surface 31a. Therefore, in the third embodiment, similarly to the second embodiment, the amount of incident light ray received by the first light receiving surface 31a can be increased more effectively than in the case where one convex curved surface increases the amount of incident light ray received by the first light receiving surface 31a.

### 4. Fourth Embodiment

Hereinafter, differences between a fourth embodiment and the first embodiment will be described. The fourth embodiment adopts the same configuration as the first embodiment for points that are not described.

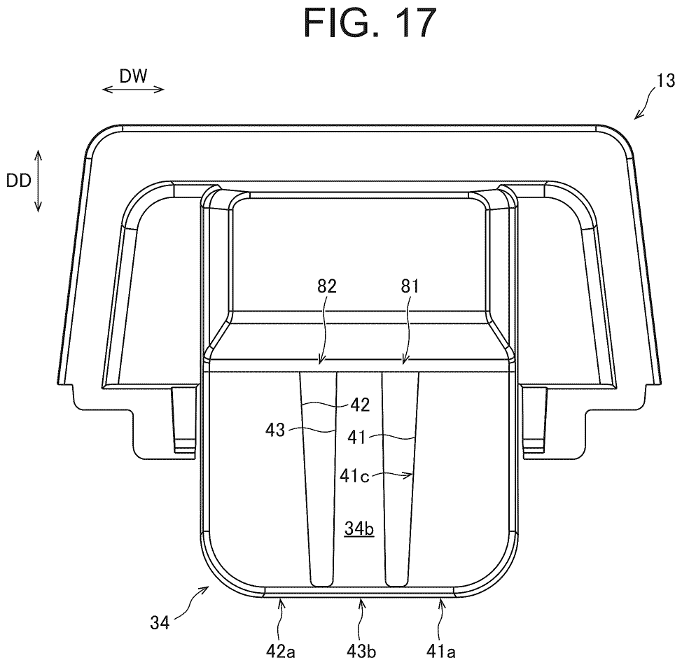

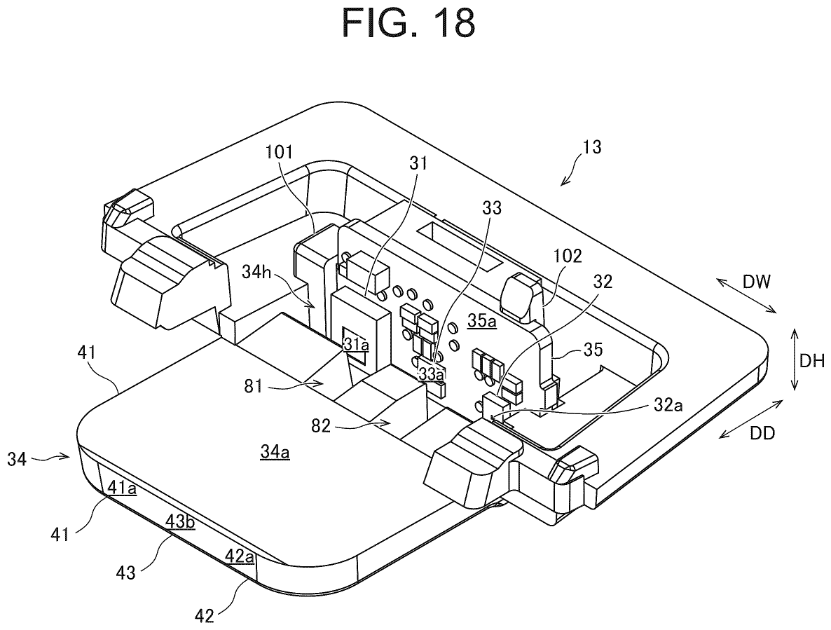

FIG. 17 is a bottom view schematically illustrating a light receiving device provided in a display apparatus of a fourth embodiment. FIG. 18 is a perspective view schematically illustrating the light receiving device provided in the display apparatus of the fourth embodiment.

In the fourth embodiment, as illustrated in FIG. 17, the first slit 81 and the second slit 82 are formed in the main surface 34a disposed on the upper side in the height direction DH on the rear side in the depth direction DD, and are formed in the main surface 34b disposed on the lower side in the height direction DH on the front side in the depth direction DD. Thus, the appearance of the indicator light can be changed as compared with the case where the first slit 81 and the second slit 82 are formed only in the main surface 34a. Other features are the same as those in the first embodiment.

The present disclosure is not limited to the above-described embodiments, and may be replaced with a configuration which is substantially the same as the configuration illustrated in the above-described embodiments, a configuration which exhibits the same operation and effect, or a configuration which can achieve the same object.

What is claimed is:

1. A light receiving device comprising:
an optical sensor having a light receiving surface; and
a light guide having an incidence surface on which a light ray is incident, an emission surface through which the light ray is emitted toward the light receiving surface, and a boundary surface that directs the light ray incident from a side where the incidence surface is present toward the light receiving surface.

2. The light receiving device according to claim 1, wherein the boundary surface is disposed outside a region on the light receiving surface.

3. The light receiving device according to claim 1,
wherein the light guide includes an other boundary surface that directs the light ray incident from the side where the incidence surface is present toward the light receiving surface to totally reflect an other light ray,
wherein the boundary surface is disposed to be shifted in one direction from a region on the light receiving surface, and
wherein the other boundary surface is disposed to be shifted from the region in an other direction.

4. The light receiving device according to claim 1, wherein the incidence surface includes a convex curved surface that refracts an incident light ray toward the emission surface or the boundary surface.

5. The light receiving device according to claim 4, wherein the convex curved surface is disposed outside a region on the light receiving surface.

6. The light receiving device according to claim 5,
wherein the boundary surface is disposed to be shifted in one direction from a region on the light receiving surface, and
wherein the convex curved surface is disposed to be shifted from the region in an other direction.

7. The light receiving device according to claim 4,
wherein the incidence surface includes an other convex curved surface that refracts an other incident light ray,
wherein the other convex curved surface is disposed to be shifted in one direction from a region on the light receiving surface, and
wherein the convex curved surface is disposed to be shifted in an other direction.

8. The light receiving device according to claim 1, wherein the incidence surface includes a flat surface that transmits an incident light ray toward the emission surface.

9. The light receiving device according to claim 8, wherein the flat surface is disposed in a region on the light receiving surface.

10. The light receiving device according to claim 1,
wherein a slit is formed in the light guide, and
wherein the boundary surface faces the slit.

11. The light receiving device according to claim 10,
wherein the light guide has a plate-like shape having a main surface, and
wherein the slit is formed in the main surface.

12. The light receiving device according to claim 1,
wherein the light receiving surface is a first light receiving surface,
wherein the optical sensor is a first optical sensor,
wherein the light ray is a first light ray,
wherein the incidence surface is a first incidence surface,
wherein the emission surface is a first emission surface,
wherein the boundary surface is a first boundary surface,
wherein the light receiving device includes a second optical sensor having a second light receiving surface and a light emitting element that emits a third light ray, and
wherein the light guide has a second incidence surface on which the second light ray is incident, a second emission surface that emits the second light ray toward the second light receiving surface, a second boundary surface that directs the second light ray toward the second light receiving surface from a side where the second incidence surface is present to a side where the second emission surface is present, a third incidence surface on which the third light ray is incident, a third emission surface that emits the third light ray, and a third boundary surface that directs the third light ray toward the third emission surface.

13. The light receiving device according to claim 12,
wherein the first light ray is included in remote control light,
wherein the second light ray is included in environmental light, and
wherein the third light ray is included in indicator light.

14. The light receiving device according to claim 1,
wherein a hole is formed in the light guide,
wherein the light guide has an inner bottom surface facing the hole, and includes a stopper spaced upwardly from the inner bottom surface by a first distance and a hook spaced upwardly from the inner bottom surface by a second distance that is longer than the first distance,
wherein the light receiving device includes a substrate that has a main surface which is housed in the hole and on which the optical sensor is mounted, a first end surface facing in a first direction and abutting on the inner bottom surface, a second end surface facing in a second direction opposite to the first direction and abutting the hook, and a third end surface facing in a third direction intersecting the first direction and the second direction and having a protrusion formed thereon that abuts the stopper from below.

15. A display apparatus comprising:
the light receiving device according to claim 1; and
a display apparatus body to which the light receiving device is attached.
